(19) United States
(12) Patent Application Publication
(10) Pub. No.: US 2018/0225260 A1
(43) Pub. Date: Aug. 9, 2018

(54) LIST DISPLAY APPARATUS, LIST DISPLAY METHOD, AND LIST DISPLAY PROGRAM

(71) Applicant: JVC KENWOOD Corporation, Yokohama-shi (JP)

(72) Inventor: Rikiya KASAHARA, Yokohama-shi (JP)

(73) Assignee: JVC KENWOOD Corporation

(21) Appl. No.: 15/889,617

(22) Filed: Feb. 6, 2018

(30) Foreign Application Priority Data
Feb. 7, 2017 (JP) 2017-020236

(51) Int. Cl. G06F 17/21; G06F 3/0481

(52) U.S. Cl. CPC G06F 17/211; G06F 3/0481

(57) ABSTRACT

A list display apparatus, a list display method, and a list display program capable of improving visibility are provided. The list display apparatus includes: a row selection unit configured to select a target row, which is one of a plurality of rows, from a list including the plurality of rows; a similarity calculation unit configured to calculate a similarity between data in the target row selected by the row selection unit and data in another row; and a list display unit configured to display the list on a list display screen based on the similarity calculated by the similarity calculation unit.

### CROSS REFERENCE TO RELATED APPLICATION

This application is based upon and claims the benefit of priority from Japanese patent application No. 2017-020236, filed on Feb. 7, 2017, the disclosure of which is incorporated herein in its entirety by reference.

### BACKGROUND

The present disclosure relates to a list display apparatus, a list display method, and a list display program, and more particularly, to a list display apparatus, a list display method, and a list display program for displaying a list including a plurality of rows.

A Graphical User Interface (GUI) employed in personal computers on which Windows (registered trademark) manufactured by Microsoft Corporation currently used widely is mounted has been widely used as a user interface of an application software. In the GUI, a list that includes a plurality of rows can be displayed in a form of a table on a window screen. Then a user is able to operate the GUI in order to find desired data from the displayed list.

For example, a method for sorting the content of the list by clicking a column header (an item name or a data name) of the displayed list has been typically used. Further, the rows of the list that are displayed are often formed of a plurality of columns (items or data), and the content of the list can be sorted by a plurality of sort conditions by selecting a plurality of column headers to be clicked.

As related art, Japanese Unexamined Patent Application Publication No. 2015-201037 is, for example, known.

### SUMMARY

In the related art, as described above, it is possible to display the list on the window screen and the content of the list can be sorted in response to a user's operation. However, when the list is composed of a large number of rows, it is impossible to display all the rows on the window screen. Accordingly, a method of displaying only some of the rows of the list on the window screen and changing the display position of the rows of the list by operating, by the user, a scroll bar has been employed. Then, in order to find desired data from a large number of lists that have been sorted, the user needs to check the data one by one by operating the scroll bar.

Accordingly, in related art, there is a problem that it is difficult to grasp desired data from the displayed list and visibility is poor.

In one embodiment, a list display apparatus including: a row selection unit configured to select a target row, which is one of a plurality of rows, from a list including the plurality of rows; a similarity calculation unit configured to calculate a similarity between data in the target row and data in another row; and a list display unit configured to display the list on a list display screen based on the similarity is provided.

Further, in another embodiment, a list display method including: selecting a target row, which is one of a plurality of rows, from a list including the plurality of rows; calculating a similarity between data in the selected row and data in another row; and displaying the list on a list display screen based on the similarity is provided.

Further, in another embodiment, a list display program for causing a computer to execute the following processing of: selecting a target row, which is one of a plurality of rows, from a list including the plurality of rows; calculating a similarity between data in the selected row and data in another row; and displaying the list on a list display screen based on the similarity is provided.

According to the aforementioned embodiments, it is possible to provide a list display apparatus, a list display method, and a list display program capable of improving visibility.

### BRIEF DESCRIPTION OF THE DRAWINGS

The above and other aspects, advantages and features will be more apparent from the following description of certain embodiments taken in conjunction with the accompanying drawings, in which:

FIG. 1 is a configuration diagram showing a configuration of a list display apparatus according to a first embodiment;

FIG. 2 is a flowchart showing a list display method according to a reference example;

FIG. 3 is a flowchart showing a list display method according to a first embodiment;

FIG. 4 is a diagram showing an example of a list display screen according to the first embodiment;

FIG. 5 is a diagram showing an example of a list displayed on the list display screen according to the first embodiment;

FIG. 6 is a diagram showing an example of the list display screen according to the first embodiment;

FIG. 7 is a diagram showing an example of a list displayed on the list display screen according to the first embodiment;

FIG. 8 is a diagram for describing a list display method according to the first embodiment;

FIG. 9 is a diagram for describing the list display method according to the first embodiment;

FIG. 10A is a flowchart showing a list display method according to a second embodiment;

FIG. 10B is a flowchart showing the list display method according to the second embodiment;

FIG. 11 is a diagram showing a specific example 1 in which display is performed by the list display method according to the second embodiment;

FIG. 12 is a diagram showing a specific example 2 in which display is performed by the list display method according to the second embodiment;

FIG. 13 is a diagram showing a specific example 3 in which display is performed by the list display method according to the second embodiment;

FIG. 14 is a diagram showing a specific example 4 in which display is performed by the list display method according to the second embodiment;

FIG. 15 is a diagram showing a specific example 5 in which display is performed by the list display method according to the second embodiment; and

FIG. 16 is a diagram showing a specific example 6 in which display is performed by the list display method according to the second embodiment.

### DETAILED DESCRIPTION

### First Embodiment

Hereinafter, with reference to the drawings, a first embodiment will be explained.

### <Configuration of List Display Apparatus According to First Embodiment>

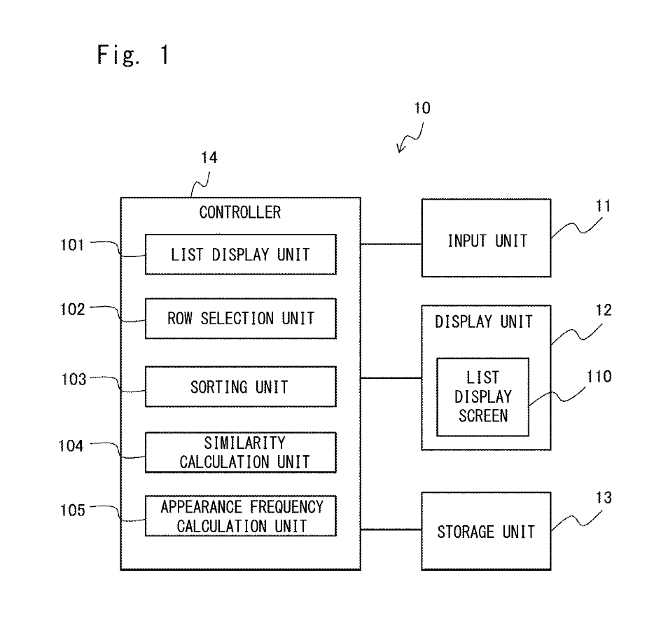

FIG. 1 shows a configuration of a list display apparatus according to this embodiment. A list display apparatus 10 according to this embodiment is an apparatus in which a list is displayed in a GUI of an application software and is composed of, for example, a computer apparatus on which Windows or the like is mounted.

As shown in FIG. 1, the list display apparatus 10 according to this embodiment includes an input unit 11, a display unit 12, a storage unit 13, and a controller 14. The input unit 11 is an input apparatus for allowing a user to perform input operations and is composed of, for example, a mouse, a key board and the like.

The display unit 12 is a display apparatus that displays the GUI such as a list display screen 110 including a list and is composed of, for example, a liquid crystal display and the like. The storage unit 13 is a storage apparatus that stores programs or various types of data (e.g., a list display program and list data) that are necessary for operations of the controller 14, and is composed of, for example, a hard disc, a memory or the like.

The controller 14 is a controller that controls operations of the list display apparatus 10 and displays the list display screen 110 on the display unit 12 in accordance with the program and the data stored in the storage unit 13 and input operations of the input unit 11. The controller 14 is composed of, for example, a Central Processing Unit (CPU) that can execute the program.

The controller 14 includes a list display unit 101, a row selection unit 102, a sorting unit 103, a similarity calculation unit 104, and an appearance frequency calculation unit 105 in order to achieve main functions of the list display apparatus 10. The functions of the respective units are achieved by the controller 14 executing the list display program stored in the storage unit 13. Other configurations may be employed as long as the list display method according to this embodiment described below can be achieved.

The list display unit 101 displays the list including a plurality of rows stored in the storage unit 13 on the list display screen 110 of the display unit 12. The row selection unit 102 selects a target row, which is one of the plurality of rows in the list displayed on the list display screen 110 in accordance with the user's operation. The sorting unit 103 sorts the list of the list display screen 110 based on the item that has been selected by the user (data in the row).

The similarity calculation unit 104 calculates the similarity between data in the target row selected in the list display screen 110 and data in another row. The appearance frequency calculation unit 105 calculates, for each similarity that has been calculated, an appearance frequency with which rows having the same similarity appear. Further, the appearance frequency calculation unit 105 also serves as a weighting unit that puts a heavier weight to a row in which the appearance frequency is large than to a row in which the appearance frequency is small in accordance with the appearance frequency of the rows having the same similarity. Then the list display unit 101 displays the list on the list display screen 110 based on the similarity that has been calculated and the weighting. That is, the list display unit 101 displays rows in which the similarity is high in preference to rows in which the similarity is low. Further, the list display unit 101 may preferentially display the row having a similarity to which a heavier weighting is applied. Further, the list display unit 101 may preferentially display a row before or after the target row in which the similarity is high in accordance with the specification by the user. While the similarity and the weighting are calculated and the display is performed after the list is sorted in this example, the similarity and the weighting may be calculated and the display may be performed without performing sorting of the list.

### <List Display Method According to Reference Example>

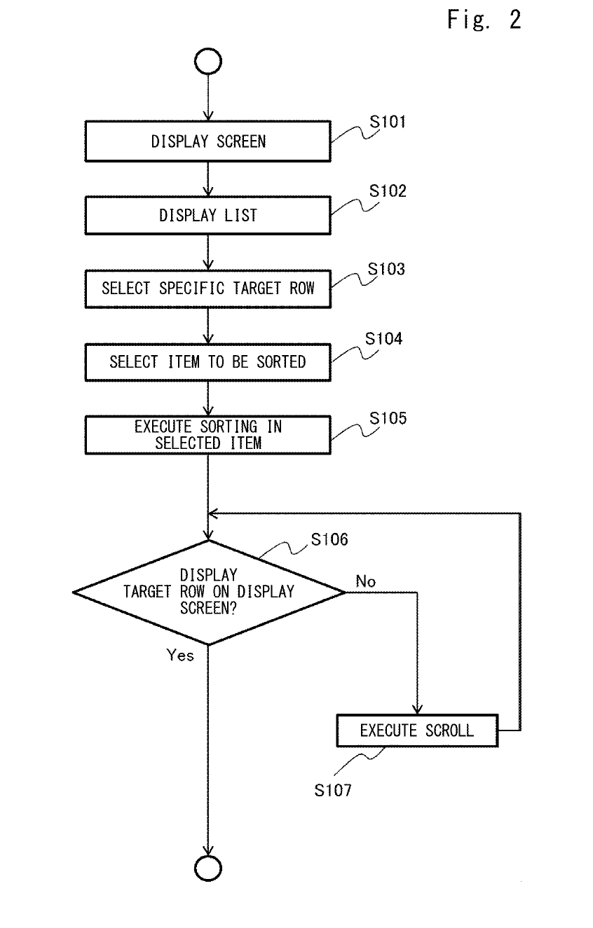

In order to facilitate the understanding of this embodiment, with reference to the flowchart shown in FIG. 2, a list display method according to a reference example, which is a reference of this embodiment, will be explained.

As shown in FIG. 2, in the list display method according to the reference example, first, the list display apparatus 10 displays the list display screen 110 (S101) and displays the list on the list display screen 110 (S102). The user operates the list display screen 110 that has been displayed, whereby the specific target row in the list is selected (S103) and the item to be sorted is selected (S104).

The list display apparatus 10 executes sorting of the list in the selected item (S105). In this case, when the target row that the user has selected is displayed on the displayed list display screen 110 (Yes in S106), the process is ended. On the other hand, when the target row is not displayed on the list display screen 110 (No in S106), the list display is scrolled in accordance with a scroll operation by the user (S107). This operation is repeated until the target row is displayed.

As described above, in the reference example, when the target row that has been selected is not displayed on the list display screen 110 as a result of that the user selected the row and the selected row was sorted the row by the user in the list display screen 110, the user needs to perform the scroll operation. Therefore, it is impossible to know where in the list the target row or a row that is close to the data in the target row is present in a simple way. Accordingly, in the reference example, there is a problem that visibility is poor and it is difficult to search for data.

In this embodiment, the result of sorting the list is displayed so that it is easy for the user to grasp, thereby achieving enhancement in visibility and the search performance.

In the method disclosed in Japanese Unexamined Patent Application Publication No. 2015-201037, the display is partitioned by the point at which the similarity is changed. However, since the frequency distribution of the similarity is not taken into consideration, the display balance before and after the target cannot be adjusted.

### <List Display Method According to First Embodiment>

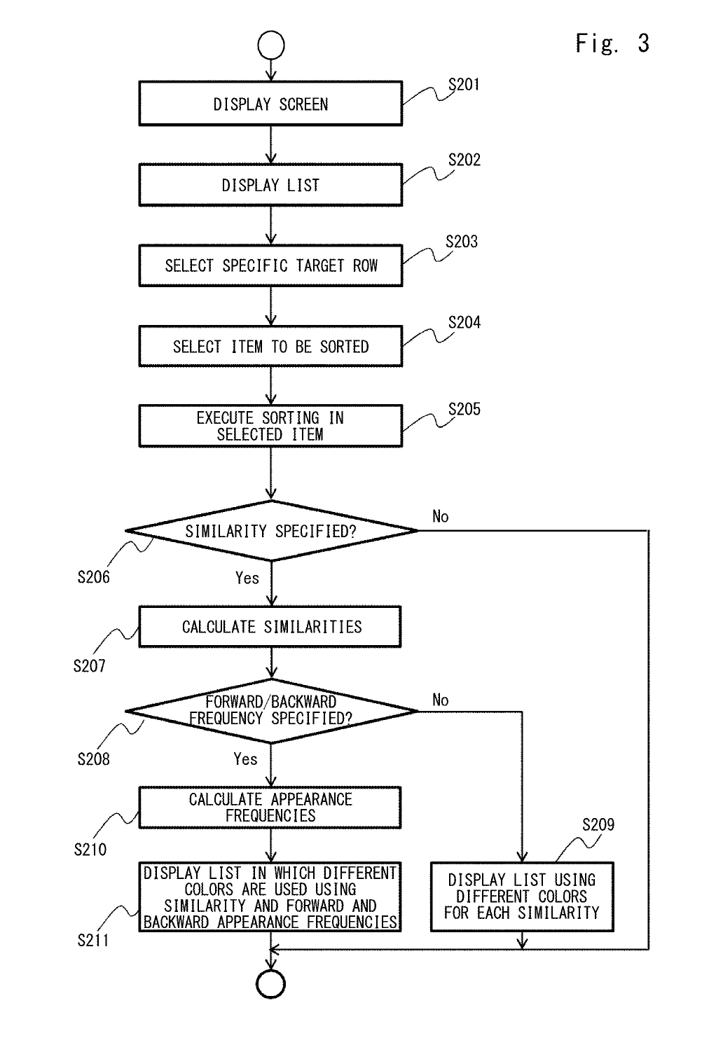

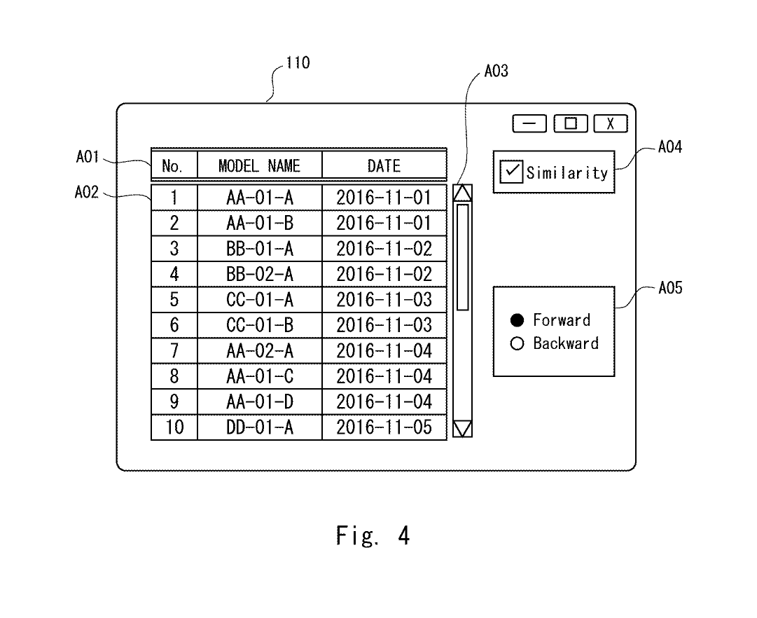

Next, with reference to the display examples shown in FIGS. 4 to 9, the list display method according to this embodiment will be explained with reference to the flowchart shown in FIG. 3. Throughout the drawings, the same elements are denoted by the same reference symbols.

As shown in FIG. 3, in the list display method according to this embodiment, first, the list display unit 101 displays the list display screen 110 on the display unit 12 (S201). FIG. 4 shows one example of the list display screen 110 displayed at this time.

As shown in FIG. 4, the list display screen 110 includes a column header A01 indicating the attribute of the column of the list, a list display area A02 for displaying information on the list, and a scroll bar A03 for displaying a list that is not displayed in the list display area A02. The displayed list includes, for example, the model name of the product that the user uses and the corresponding date, and the user searches this list for the row that includes the corresponding model name and date.

Further, the list display screen 110 includes a similarity display check box A04 and an appearance frequency selection button A05, which are the features of this embodiment. For example, the similarity calculation unit 104 calculates the similarity of each row of the list in accordance with the check in the similarity display check box A04, the appearance frequency calculation unit 105 calculates the appearance frequency specified by the appearance frequency selection button A05, and the list display unit 101 displays the list in the list display area A02 based on the similarity and the appearance frequency.

The similarity display check box A04 is a check box for specifying switching to the display that uses the similarity. By checking the check box “Similarity”, the position of the displayed rows is moved based on a row in which the similarity is high. Further, by changing colors for each similarity, the display can be made clear for the user and visibility is improved.

The appearance frequency selection button A05 is a radio button for selecting the display method using the appearance frequency. The button “Forward” is a button for displaying rows before the target row in preference to rows after the target row and the button “Backward” is a button for displaying the rows after the target row in preference to the rows before the target row. “Forward” is the forward side in the row direction in which the rows in the list are arranged, and “Backward” is the backward side in the row direction. By operating the appearance frequency selection button A05, the priority order that is displayed in the forward or backward can be determined based on a row in which the similarity is high and the target row. Even in this case, by changing colors for each similarity, the display can be made clear for the user and visibility is improved.

While the example of the sorting by one column header is shown in order to simplify the explanation in this embodiment, it will be easily understood that the list display method according to this embodiment can be employed also in the sort condition by a combination of the plurality of column headers. When, for example, the sorting is conducted using “date” as a first sort condition and there is a list of the same date, the list part of the same date may be arranged in the order of the model name using “model name” as a second sort condition. Next, the list display unit 101 displays the list on the list display screen 110 (S202).

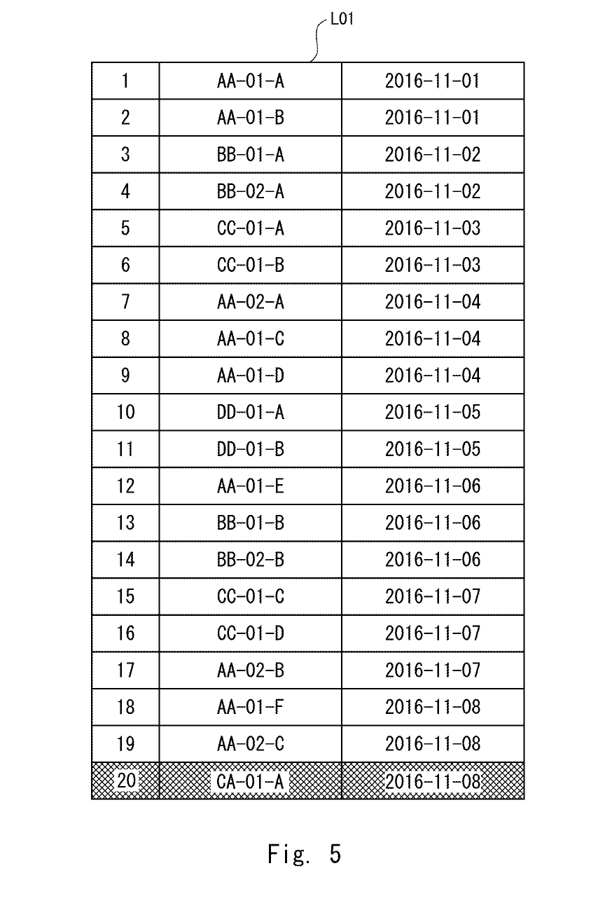

FIG. 5 shows one example of the information on the whole list for the display in the list display area A02 of the list display screen 110.

In the example shown in FIG. 5, a list L01 is composed of data of 20 rows, and the respective rows are arranged in an ascending order of the number of the “No” column of the column header A01. Then ten rows in the list L01 (e.g., from the first to the tenth rows) are displayed in the list display area A02 of the list display screen 110.

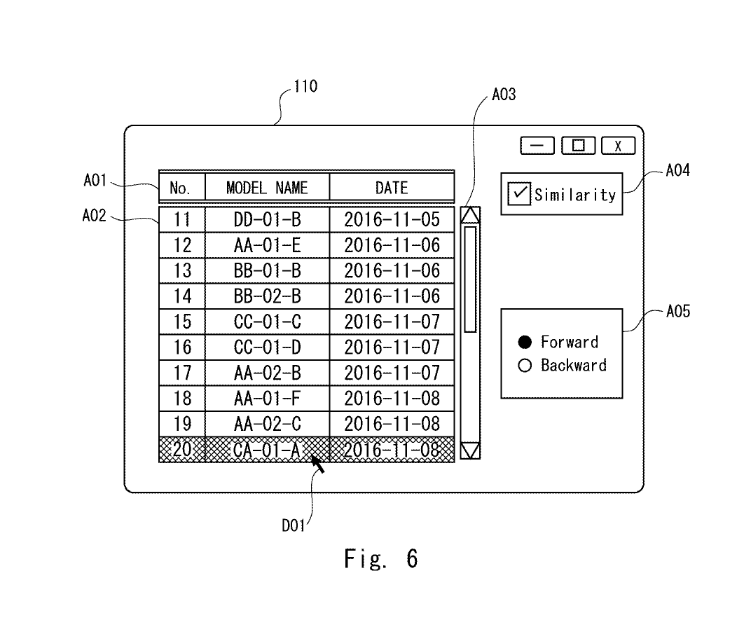

Consider a case in which the user searches the list L01 for the row “model name”, which is the target, as the target row and performs an operation for obtaining information on the list “model name” similar to the target row. First, when the target row cannot be found in the list currently displayed in the list display area A02, the user operates the scroll bar A03 to display the rows that are not currently displayed. Then the row selection unit 102 selects the specific target row in the displayed list in accordance with the operation by the user (S203). FIG. 6 shows a display example in this case.

As shown in FIG. 6, for example, the user operates the scroll bar A03, thereby scrolling the list L01 in such a way that the rows in which the “No” column is from 11 to 20 in the list L01 are displayed. In this case, if the user discovers the “model name=CA-01-A” in the “No=20” as the target row, the user clicks the target row that has been discovered with a mouse pointer D01 by operating the mouse. In response to this click operation, the row selection unit 102 selects the target row to display the background color of the target row in a reversed manner.

Next, the sorting unit 103 selects the item to be sorted in accordance with the user's operation (S204) and executes sorting of the list in the selected item (S205). After the user selects the target row as shown in FIG. 6, the user selects one of the items in the column header A01.

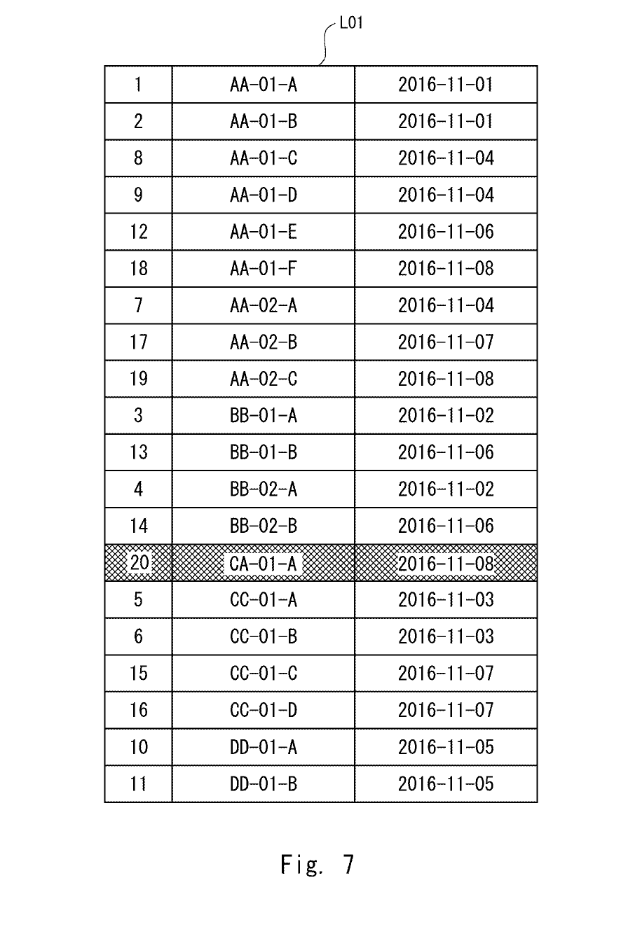

The user clicks, for example, the “model name” part of the column header A01 with the mouse pointer D01 in order to obtain the list “model name” similar to the target row. In response to this operation, the sorting unit 103 executes sorting, and the list sorted by the “model name” is obtained. Alternatively, another method of clicking the “model name” part at the time of selection operation for reversing the background color of the target row to concurrently perform the selection of the target row and the sorting by the “model name” may be employed. Further, regarding the sorting order, the ascending order and the descending order may be toggle displayed every time the column header A01 is clicked. FIG. 7 shows a result of sorting the list L01 shown in FIG. 5 by the “model name” in the ascending order. The ten rows (e.g., from the first to tenth rows) in the list L01 after the sorting may be displayed in the list display area A02 of the list display screen 110.

Next, the similarity calculation unit 104 determines whether the display using the similarity has been specified (S206). When the display that uses the similarity has not been specified in the similarity display check box A04, the process ends. On the other hand, when the display that uses the similarity has been specified by the user's operation, the similarity calculation unit 104 calculates the similarities in the respective rows in the list that is being displayed (S207). Further, the appearance frequency calculation unit 105 determines whether the forward frequency or the backward frequency has been specified (S208).

When the forward frequency (“Forward”) or the backward frequency (“Backward”) has not been specified by the appearance frequency selection button A05, the list display unit 101 displays the list in which different colors are used for each similarity that has been calculated in the list display area A02 (S209). For example, the similarity may be the number of characters that continuously coincide with each other from the top of the information on the rows, and the display position of the information on the target row is automatically adjusted in accordance with the similarity of information on the rows before and after the target row that are continuous with the target row after the sorting.

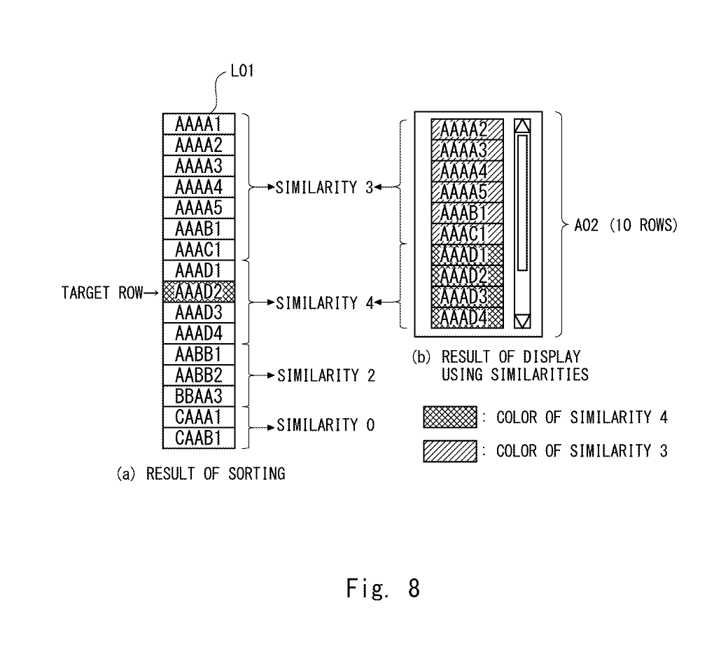

As one example, a result of sorting of one character string list L01 is shown in FIG. 8(a). When there is a character string “AAAD2” in the target row, the similarity between the target row and each row is obtained from the expression defined by the following (Expression 1). The similarity may be the number of characters that coincide with each other in a desired position such as not only at the top of the row but also at the bottom of the row. Further, the similarity may be the number of characters that coincide with each other in a part of data included in the target row.

Similarity=the number of characters that continuously coincide with each other from the top of the character string of the target row (Expression 1)

When, for example, the number of rows that can be displayed in the list display area A02 of the list display screen 110 is ten rows and there are ten or more rows that have the similarity the same as that of the target row, the target row is displayed in the central position of the list display area A02. Further, when there are less than ten rows that have the similarity the same as that of the target row, the display position of the target row is determined in such a way that all the rows that have the similarity the same as that of the target row are displayed and a large number of rows that are positioned before and after the target row and have similarities close to the similarity of the target row are displayed as many as possible.

As shown in FIG. 8(a), the display position of the target row is adjusted based on the similarity obtained in the aforementioned (Expression 1). As shown in FIG. 8(b), a large number of rows in which the similarity is high are displayed. In this case, there are four rows in which the similarity is 4, seven rows in which the similarity is 3, three rows in which the similarity is 2, and two rows in which the similarity is 0. Since there are ten rows in the list display area A02, all the rows in which the similarity is 4 including the target row can be displayed. Then the adjustment is performed by additionally displaying six rows from rows in which the similarity is 3, which is the second highest similarity, whereby it is possible to obtain the result of sorting in which visibility and the search performance are high.

In this example, there are rows in which the similarity is 3 only before the rows in which the similarity is 4. However, if there are rows in which the similarity is 3 before and after the rows in which the similarity is 4, the position of the target row is adjusted in such a way that all the rows in which the similarity is 4 are displayed and then all the rows in which the similarity is 3 are displayed. Further, when all the rows in which the similarity is 3 cannot be displayed in the list display area A02, adjustment is performed in such a way that the rows in which the similarity is 3 are displayed before and after the rows in which the similarity is 4 and the number of rows in which the similarity is 3 before the rows in which the similarity is 4 becomes the same as the number of rows in which the similarity is 3 after the rows in which the similarity is 4. When there is an available space in the list display area A02 even after all the rows in which the similarity is 3 are displayed, the display position is determined in such a way that the rows in which the similarity is 2 are displayed by a similar method. Further, by displaying the respective rows while changing colors of the rows for each similarity, visibility and the search performance can be enhanced.

On the other hand, when the forward frequency (“Forward”) or the backward frequency (“Backward”) has been specified by the appearance frequency selection button A05, the appearance frequency calculation unit 105 calculates the forward and backward appearance frequencies (S210), and the list display unit 101 displays the list in which different colors are used using the forward and backward appearance frequencies that have been calculated in the list display area A02 (S211). For example, using the appearance frequency as the number of pieces of information having the same similarity, the forward frequency as the appearance frequency that exists in the forward with respect to the information in the target row after the sorting, and the backward frequency as the appearance frequency that exists in the backward with respect to the information in the target row after the sorting, the display position of the information in the target row is automatically adjusted in accordance with the ratio of the similarity to the forward frequency and the backward frequency.

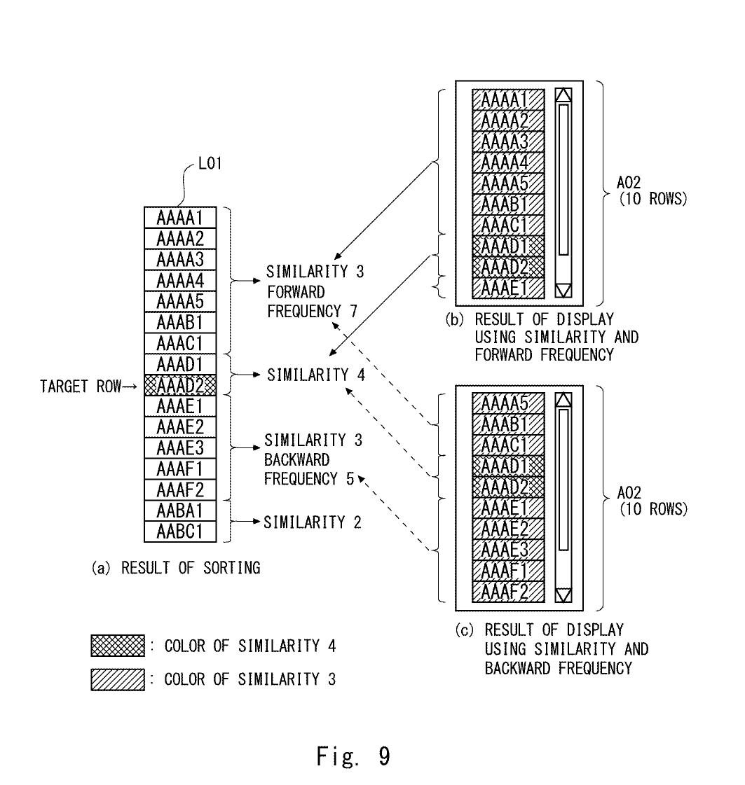

As one example, a result of sorting of one character string list L01 is shown in FIG. 9(a). In this example, unlike the example shown in FIG. 8, an explanation will be given using, as an example, a result of sorting when there are a large number of rows having a similarity the same as that of the target row before and after the target row. In this example, the appearance frequency is obtained from the following (Expression 2).

Appearance frequency=number of rows having the same similarity (Expression 2)

In the example shown in FIG. 9(a), the appearance frequency of the similarity 3 before the target row is 7, and the appearance frequency of the similarity 3 after the target row is 5. When the forward frequency is specified, as shown in FIG. 9(b), rows before the target row in which the similarity is high are preferentially displayed. All the rows in which the similarity is 4 and all the rows in the forward in which the similarity is 3 are displayed, and then one row in the backward in which the similarity is 3 is displayed. Further, when the backward frequency is specified, as shown in FIG. 9(c), rows after the target row in which the similarity is high are preferentially displayed. All the rows in which the similarity is 4 and the rows in the backward in which the similarity is 3 are displayed, and then three rows in the forward in which the similarity is 3 are displayed. Further, even in this case, by displaying the rows by changing colors thereof for each similarity, visibility and the search performance can be enhanced. The display may be performed in such a way that the rows that could not be displayed in the list display area A02 in the rows that have the same similarity can be easily seen. For example, the number of rows that cannot be displayed may be displayed.

### <Effects of First Embodiment>

As described above, in this embodiment, in the list display apparatus that displays the list on the screen, after the target row is selected in response to the user's operation and sorting is executed, rows having similarities that are close to that of the target row are preferentially displayed and rows before or after the target row in which the appearance frequency is high are preferentially displayed. Accordingly, it becomes possible to display a large number of rows including the target row and the rows that are similar to the target row without losing the target row after the sorting.

In this embodiment, since the display method of the target object selected by the user can be specified by the user after the sorting, the result of the sorting can be easily checked. Further, the user does not need to finely adjust the position in consideration of the display balance. This is particularly effective when a list that includes an enormous number of pieces of data is handled.

Further, it is possible not only to prevent the target object from being lost as a result of sorting but also to enhance visibility of the result of sorting and the search performance according to this embodiment. Further, since the display position is determined from the result of sorting, which is difficult to be predicted, it is possible to display a large number of pieces of similarity information and to easily find the same or similar information.

### Second Embodiment

Hereinafter, with reference to the drawings, a second embodiment will be explained. While the means for specifying, by the user, the weighting in the forward and backward by the appearance frequency selection button A05 shown in FIG. 6 has been employed in the first embodiment, means for automatically determining the display position of the list from the distribution of the forward and backward appearance frequencies is provided in the second embodiment. While the configuration in which the appearance frequency selection button A05 shown in FIG. 6 is unnecessary is employed in the second embodiment, the effects obtained in the second embodiment are similar to those obtained in the first embodiment.

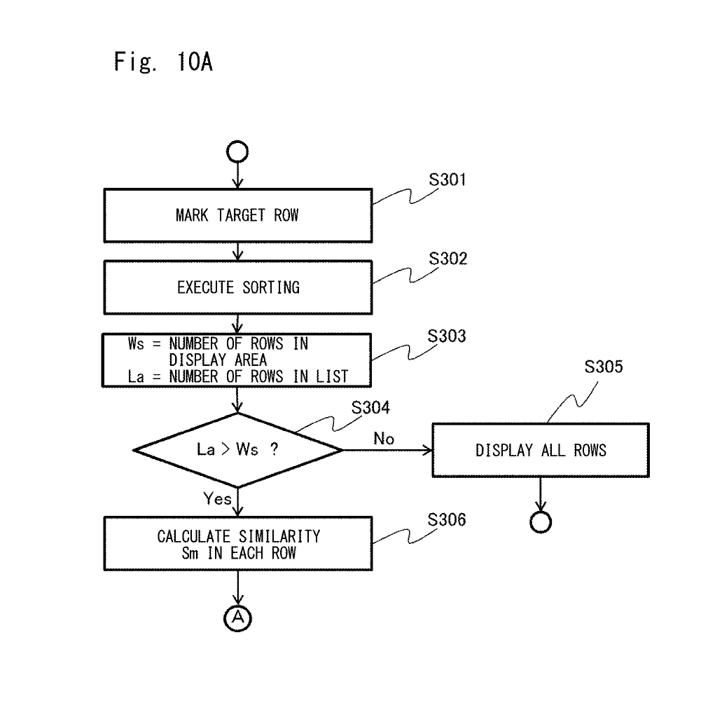

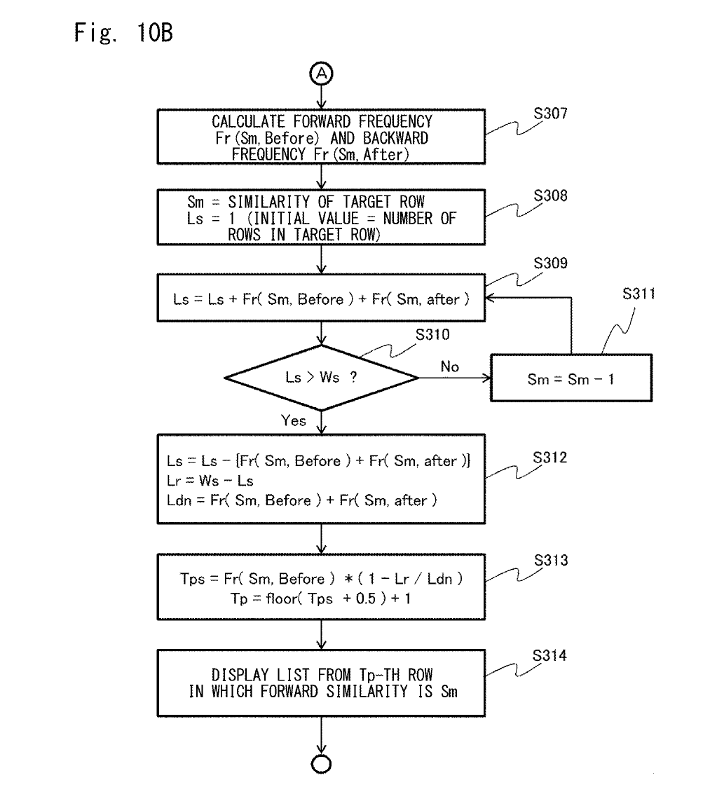

The flowchart shown in FIGS. 10A and 10B shows specific examples of the list display method in FIG. 3.

First, corresponding to S201-S205 of FIG. 3, the list is displayed in the list display area A02 of the list display screen 110, the target row in the list is marked in response to the user's operation (S301), and the sorting is executed in accordance with the sort condition that has been selected (S302).

In the following processes, corresponding to S206-S211 shown in FIG. 3, the list is displayed in the list display area A02 based on the similarities of the respective rows and the appearance frequencies.

First, the list display unit 101 sets the number of rows (Ws) in the list display area A02 and the number of rows in the list (La) (S303), and compares both of them (S304). When the number of rows in the list (La) is equal to or smaller than the number of rows (Ws) in the list display area A02, the list display unit 101 displays all the lists in the list display area A02 (S305), and the process is ended.

Further, when the number of rows in the list (La) is larger than the number of rows (Ws) in the list display area A02, the similarity calculation unit 104 calculates the similarity Sm between the target row and each row (S306). As described in the aforementioned (Expression 1), the character string in the target row and that in each row are compared with each other, and the number of characters that coincide with each other from the top is obtained.

Next, the appearance frequency calculation unit 105 calculates the forward frequency (Fr(Sm,Before)) and the backward frequency (Fr(Sm,After)) with respect to the target row (S307). As shown in the aforementioned (Expression 2), the number of rows before the target row that have the same similarity is obtained as the forward frequency and the number of rows after the target row that have the same similarity is obtained as the backward frequency.

Next, in order to determine the list to be displayed in the list display area A02, the list display unit 101 sets the similarity of the target row as a reference similarity (Sm) to be referred, and initially sets the number of rows to be obtained (Ls) for the rows to be displayed to 1, which is the number of rows in the target row (S308). Then, the list display unit 101 adds the forward frequency (Fr(Sm,Before)) and the backward frequency (Fr(Sm,After) of the reference similarity (Sm) to the number of rows to be obtained (Ls) (S309), and compares the number of rows to be obtained (Ls) with the number of rows (Ws) in the list display area A02 (S310).

When the number of rows to be obtained (Ls) is equal to or smaller than the number of rows (Ws) in the list display area A02, the reference similarity is decremented (S311) and the process of adding the forward frequency and the backward frequency of the reference similarity (S309) is repeated to obtain the range of the list having the similarities that can be all displayed in the list display area A02. Next, the process goes to a step of determining the position of the row of the similarity in the forward in which only a part of the list can be displayed in the list display area A02, that is, a display start row (Tp). When the number of rows to be obtained (Ls) is larger than the number of rows (Ws) in the list display area A02, the list display unit 101 subtracts the forward frequency and the backward frequency in the last (current) reference similarity from the number of rows to be obtained (Ls), subtracts the number of rows to be obtained (Ls) from the number of rows (Ws) in the list display area A02 to obtain the number of blank rows (Lr), and obtains the total number of rows (Ldn) of the forward frequency and the backward frequency of the last reference similarity (S312). From these values, the row in the list to be displayed is obtained (S313). Specifically, the forward frequency of the reference similarity is multiplied by ((1−Lr (the number of blank rows))/Ldn (the total number of rows of the forward frequency and the backward frequency)), the result is round-off, and 1 is added to the resultant value to obtain the display start row (Tp).

Then the list is displayed, with the Tp-th row from the top of the row having the forward similarity (Sm) being the top row of the list display area A02 (S314). However, when there is no row that has the forward similarity (Sm), the top of the row that is the closest to the similarity (Sm) and has a high-order forward similarity is set to the top row of the display.

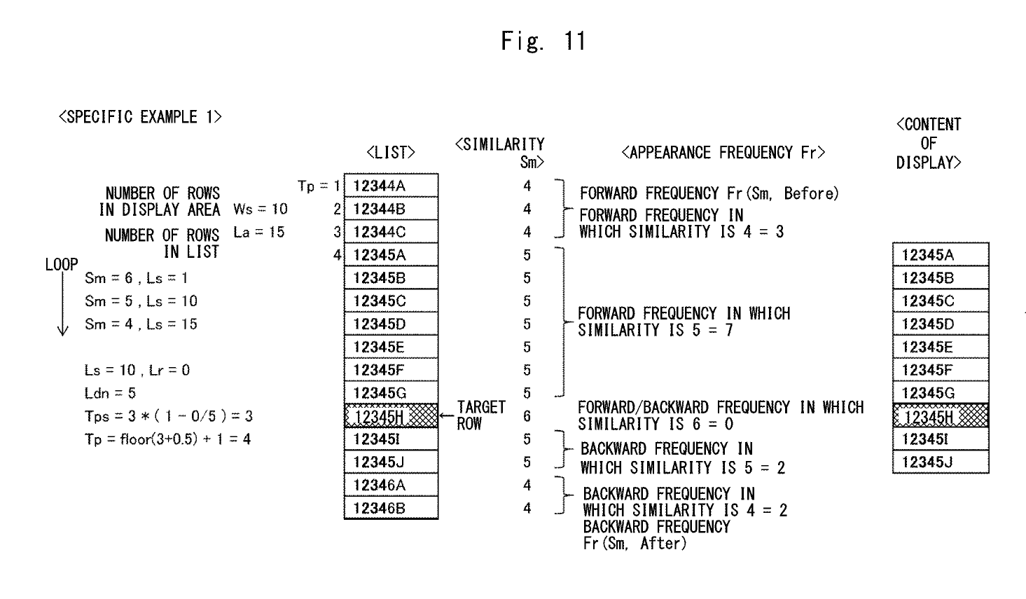

In the following description, with reference to FIGS. 11 to 16, specific examples of FIGS. 10A and 10B will be explained.

### Specific Example 1

FIG. 11 shows a list and a display example according to a specific example 1. The specific example 1 is an example in which the display area is filled with the rows having the same similarity.

As shown in FIG. 11, it is assumed that the number of rows (Ws) in the list display area A02 is 10, the number of rows in the list (La) is 15, and the row “12345H” in the list is set to be the target row. Then, from S307 shown in FIG. 10B, the forward/backward frequency in which the similarity is 6 is 0, the forward frequency in which the similarity is 5 is 7, the backward frequency in which the similarity is 5 is 2, the forward frequency in which the similarity is 4 is 3, and the backward frequency in which the similarity is 4 is 2.

From the loop of S309 to S311 shown in FIG. 10B, the reference similarity (Sm) and the number of rows to be obtained (Ls) are repeated like (Sm=6, Ls=1), (Sm=5, Ls=10), and (Sm=4, Ls=15).

After the loop, from S313 and S314 shown in FIG. 10B, the number of rows to be obtained (Ls), the number of blank rows (Lr), and the number of rows (Ldn) at the last forward frequency and backward frequency are expressed by (Ls=10, Lr=0, Ldn=5). From these values, the display start row becomes (Tp=4).

Therefore, ten rows from “12345A” to “12345J” in Tp=4 are displayed in the list display area A02. Accordingly, the target row, the seven rows in the forward in which the similarity is 5, the two rows in the backward in which the similarity is 5 are displayed in the list display area A02.

### Specific Example 2

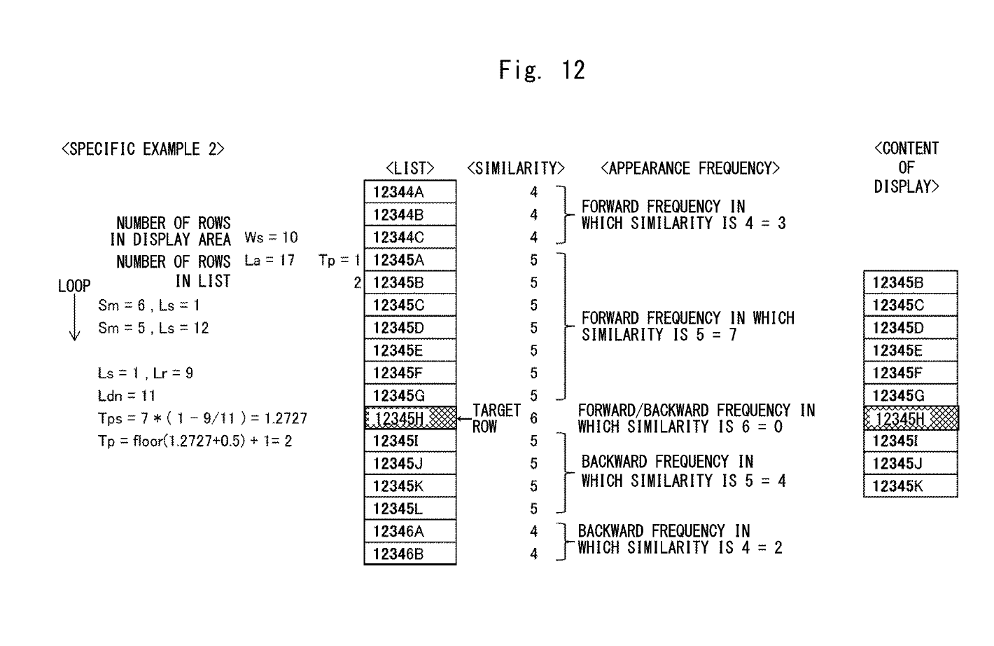

FIG. 12 shows a list and a display example in a specific example 2. The specific example 2 is an example in which the display area is filled with the rows having the same similarity and that the backward frequency becomes large is reflected in the position of the target row.

As shown in FIG. 12, it is assumed that the number of rows (Ws) in the list display area A02 is 10, the number of rows in the list (La) is 17, and the row “12345H” in the list is set to be the target row. Then, from S307 shown in FIG. 10B, the forward/backward frequency in which the similarity is 6 is 0, the forward frequency in which the similarity is 5 is 7, the backward frequency in which the similarity is 5 is 4, the forward frequency in which the similarity is 4 is 3, and the backward frequency in which the similarity is 4 is 2.

From the loop of S309 to S311 shown in FIG. 10B, the reference similarity (Sm) and the number of rows to be obtained (Ls) are repeated like (Sm=6, Ls=1) and (Sm=5, Ls=12).

After the loop, from S313 and S314 shown in FIG. 10B, the number of rows to be obtained (Ls), the number of blank rows (Lr), and the number of rows (Ldn) in the last forward frequency and backward frequency become (Ls=1, Lr=9, Ldn=11). From these values, the display start row becomes (Tp=2).

Therefore, the ten rows from “12345B” to “12345K” in Tp=2 are displayed in the list display area A02. Accordingly, the target row, the six rows in the forward in which the similarity is 5, and the three rows in the backward in which the similarity is 5 are displayed in the list display area A02.

### Specific Example 3

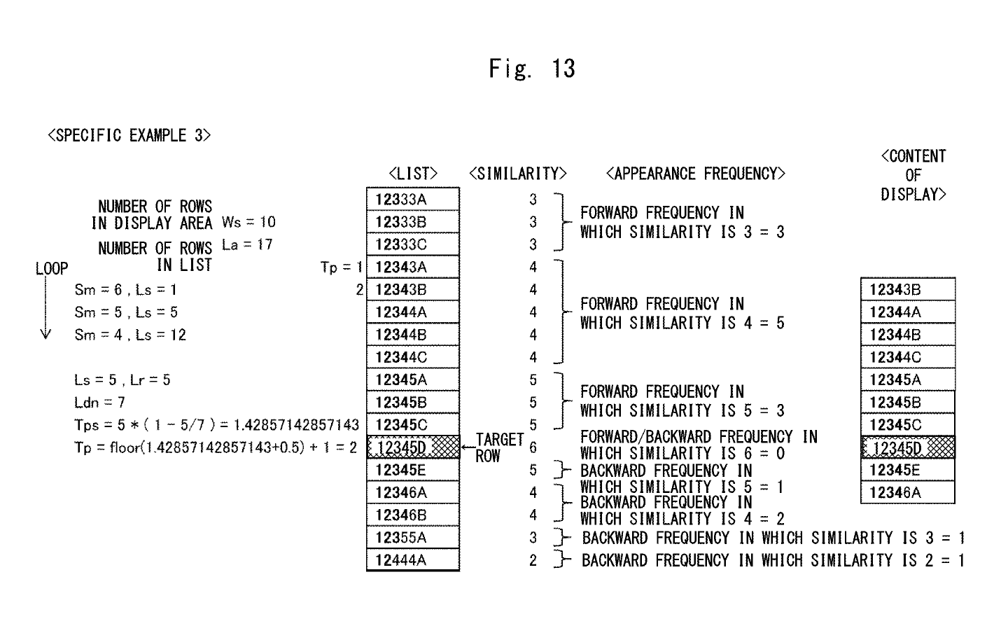

FIG. 13 shows a list and a display example according to a specific example 3. The specific example 3 is an example in which rows having similarities different from each other are displayed in the display area.

As shown in FIG. 13, it is assumed that the number of rows (Ws) in the list display area A02 is 10, the number of rows in the list (La) is 17, and the row “12345D” in the list is set to be the target row. Then, from S307 shown in FIG. 10B, the forward/backward frequency in which the similarity is 6 is 0, the forward frequency in which the similarity is 5 is 3, the backward frequency in which the similarity is 5 is 1, the forward frequency in which the similarity is 4 is 5, the backward frequency in which the similarity is 4 is 2, the forward frequency in which the similarity is 3 is 3, the backward frequency in which the similarity is 3 is 1, and the backward frequency in which the similarity is 2 is 1.

From the loop of S309 to S311 shown in FIG. 10B, the reference similarity (Sm) and the number of rows to be obtained (Ls) are repeated like (Sm=6, Ls=1), (Sm=5, Ls=5), and (Sm=4, Ls=12).

After the loop, from S313 and S314 shown in FIG. 10B, the number of rows to be obtained (Ls), the number of blank rows (Lr), and the number of rows (Ldn) in the last forward frequency and backward frequency is (Ls=5, Lr=5, Ldn=7). From these values, the display start row becomes (Tp=2).

Therefore, the ten rows from “12343B” to “12346A” in Tp=2 are displayed in the list display area A02. Accordingly, the target row, the three rows in the forward in which the similarity is 5, the four rows in the forward in which the similarity is 4, the one row in the backward in which the similarity is 5, and the one row in the backward in which the similarity is 4 are displayed in the list display area A02.

### Specific Example 4

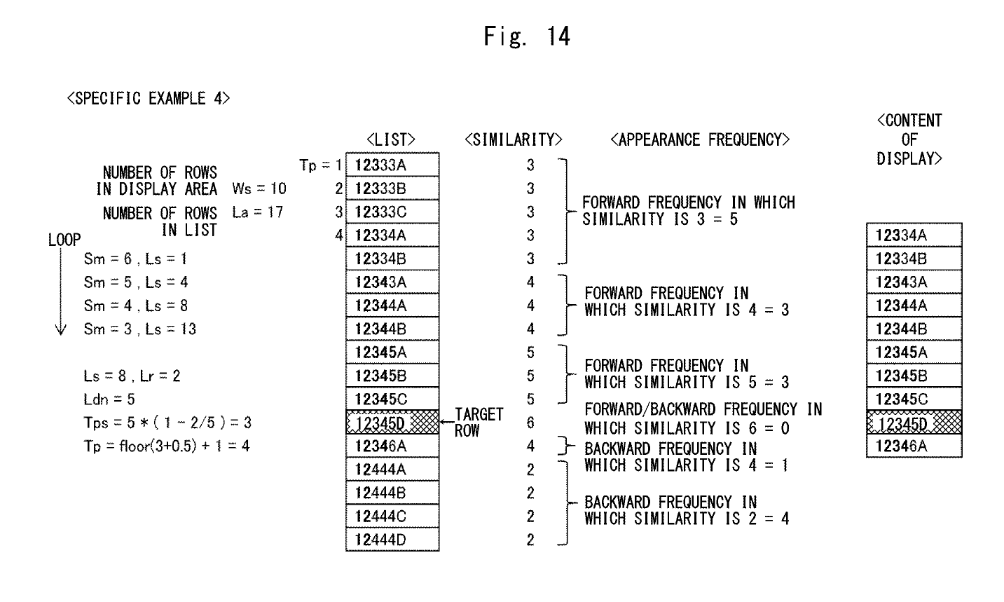

FIG. 14 shows a list and a display example according to a specific example 4. The specific example 4 is an example in which rows having similarities different from each other are displayed in the display area and the similarity at the top and that at the bottom are different from each other.

As shown in FIG. 14, it is assumed that the number of rows (Ws) in the list display area A02 is 10, the number of rows in the list (La) is 17, and the row “12345D” in the list is set to be the target row. Then, from S307 shown in FIG. 10B, the forward/backward frequency in which the similarity is 6 is 0, the forward frequency in which the similarity is 5 is 3, the forward frequency in which the similarity is 4 is 3, the backward frequency in which the similarity is 4 is 1, the forward frequency in which the similarity is 3 is 5, and the backward frequency in which the similarity is 2 is 4.

From the loop of S309 to S311 shown in FIG. 10B, the reference similarity (Sm) and the number of rows to be obtained (Ls) are repeated like (Sm=6, Ls=1), (Sm=5, Ls=4), (Sm=4, Ls=8), and (Sm=3, Ls=13).

After the loop, from S313 and S314 shown in FIG. 10B, the number of rows to be obtained (Ls), the number of blank rows (Lr), and the number of rows (Ldn) in the last forward frequency and backward frequency become (Ls=8, Lr=2, Ldn=5). From these values, the display start row becomes (Tp=4).

Therefore, the ten rows from “12334A” to “12346A” in Tp=4 are displayed in the list display area A02. Accordingly, the target row, the three rows in the forward in which the similarity is 5, the three rows in the forward in which the similarity is 4, the two rows in the forward in which the similarity is 3, and the one row in the backward in which the similarity is 4 are displayed in the list display area A02.

### Specific Example 5

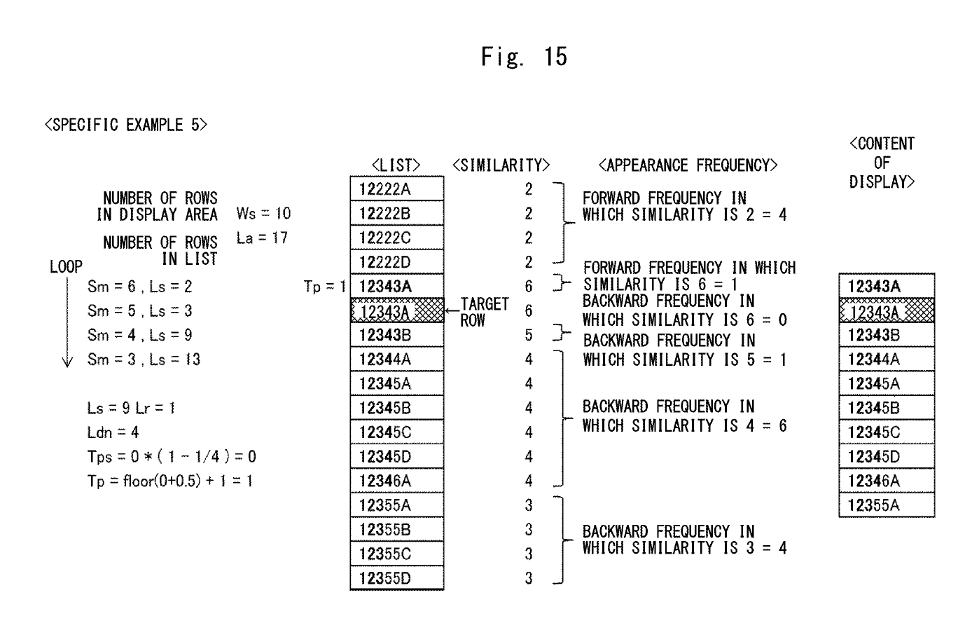

FIG. 15 shows a list and a display example according to a specific example 5. The specific example 5 is an example in which there is a row that is the same as the target row and there is no row that has the forward similarity that should be displayed in S314 of FIG. 10B.

As shown in FIG. 15, it is assumed that the number of rows (Ws) in the list display area A02 is 10, the number of rows in the list (La) is 17, and the row “12343A” (the second row) in the list is set to be the target row. Then, from S307 shown in FIG. 10B, the backward frequency in which the similarity is 6 is 0, the forward frequency in which the similarity is 6 is 1, the backward frequency in which the similarity is 5 is 1, the backward frequency in which the similarity is 4 is 6, the backward frequency in which the similarity is 3 is 4, and the forward frequency in which the similarity is 2 is 4.

From the loop of S309 to S311 shown in FIG. 10B, the reference similarity (Sm) and the number of rows to be obtained (Ls) are repeated like (Sm=6, Ls=2), (Sm=5, Ls=3), (Sm=4, Ls=9), and (Sm=3, Ls=13).

After the loop, from S313 and S314 shown in FIG. 10B, the number of rows to be obtained (Ls), the number of blank rows (Lr), and the number of rows (Ldn) in the last forward frequency and backward frequency become (Ls=9, Lr=1, Ldn=4). From these values, the display start row becomes (Tp=1).

Since there is no row in the forward in which the similarity is 3, the ten rows from the first row “12343A” in Tp=1 in which the similarity is 6 to the row “12355A” are displayed in the list display area A02. Accordingly, the target row, the one row in the forward in which the similarity is 6, the one row in the backward in which the similarity is 5, the six rows in the backward in which the similarity is 4, and the one row in the backward in which the similarity is 3 are displayed in the list display area A02.

### Specific Example 6

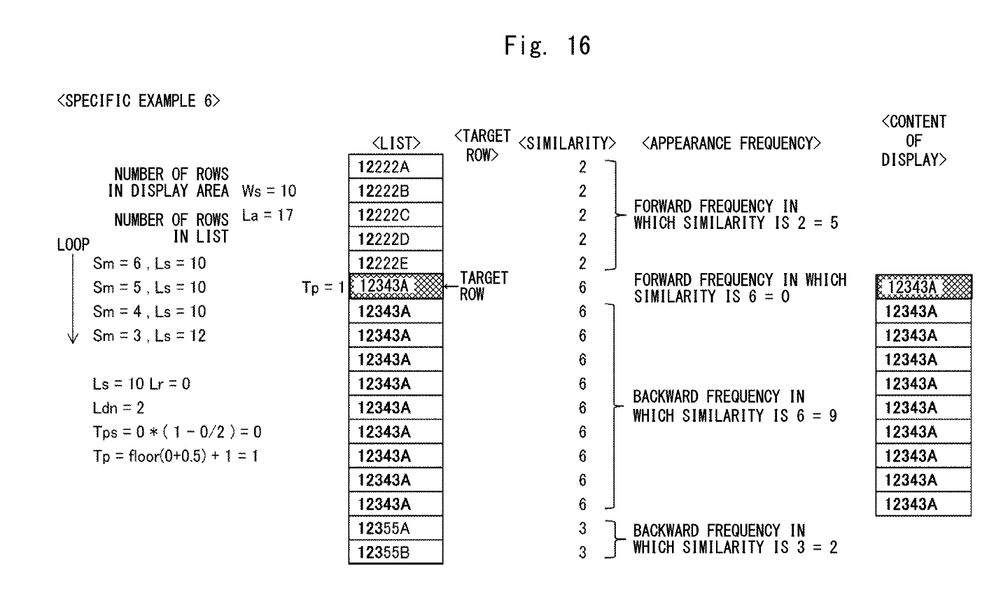

FIG. 16 shows a list and a display example according to a specific example 6. The specific example 6 is an example in which the display area is filled with only the rows that are the same as the target row and there is no row that has the forward similarity that should be displayed in S314 of FIG. 10B.

As shown in FIG. 16, it is assumed that the number of rows (Ws) in the list display area A02 is 10, the number of rows in the list (La) is 17, and the row “12343A” (the first row) in the list is set to be the target row. Then, from S307 shown in FIG. 10B, the forward frequency in which the similarity is 6 is 0, the backward frequency in which the similarity is 6 is 9, the backward frequency in which the similarity is 3 is 2, and the forward frequency in which the similarity is 2 is 5.

From the loop of S309 to S311 shown in FIG. 10B, the reference similarity (Sm) and the number of rows to be obtained (Ls) are repeated like (Sm=6, Ls=10), (Sm=5, Ls=10), (Sm=4, Ls=10), and (Sm=3, Ls=12).

After the loop, from S313 and S314 shown in FIG. 10B, the number of rows to be obtained (Ls), the number of blank rows (Lr), and the number of rows (Ldn) in the last forward frequency and backward frequency are (Ls=10, Lr=0, Ldn=2). From these values, the display start row becomes (Tp=1).

Since there is no row in the forward in which the similarity is 3, the ten rows from the top row “12343A” (the first row) in Tp=1 to the row “12343A” (the tenth row) in which the similarity is 6 are displayed in the list display area A02. Accordingly, the target row and the nine rows in the backward in which the similarity is 6 are displayed in the list display area A02.

Note that the present disclosure is not limited to the aforementioned embodiments and may be changed as appropriate without departing from the spirit of the present disclosure.

The apparatus according to the aforementioned embodiments may be composed of hardware, software, or both of them. The apparatus according to the aforementioned embodiments may be composed of one hardware apparatus or one software apparatus, or may be composed of a plurality of hardware apparatuses or a plurality of software apparatuses. The respective functions (the respective processing) of the list display apparatus may be achieved by a computer including a CPU and a memory. For example, a program for performing the list display method in the embodiments may be stored in the storage apparatus and each function may be achieved by executing the program stored in the storage apparatus by the CPU.

The program(s) can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A list display apparatus comprising:
a row selection unit configured to select a target row, which is one of a plurality of rows, from a list including the plurality of rows;
a similarity calculation unit configured to calculate a similarity between data in the target row and data in another row; and
a list display unit configured to display the list on a list display screen based on the similarity.

2. The list display apparatus according to claim 1, wherein the list display unit displays a row having a high similarity in preference to a row having a low similarity.

3. The list display apparatus according to claim 1, further comprising a sorting unit configured to sort the list based on the data in the plurality of rows,
wherein the similarity calculation unit calculates the similarity of each row in the list that has been sorted.

4. The list display apparatus according to claim 1, wherein
the data included in the plurality of rows is character string data, and
the similarity is the number of characters that are identical to each other in the character string data.

5. The list display apparatus according to claim 4, wherein the similarity is the number of characters that are continuously identical to each other from the top in the character string data.

6. The list display apparatus according to claim 1, further comprising an appearance frequency calculation unit that adds weight in accordance with an appearance frequency of rows having the same similarity for each of the similarities that have been calculated.

7. The list display apparatus according to claim 6, wherein the list display unit displays rows that have the same similarity in accordance with the weighting.

8. The list display apparatus according to claim 7, wherein
the weighting comprises weighting of a row which is before or after the target row in a row direction in which the rows in the list are arranged, and
the list display unit preferentially displays a row before or after the rows having the same similarity.

9. A list display method comprising:
selecting a target row, which is one of a plurality of rows, from a list including the plurality of rows;
calculating a similarity between data in the selected row and data in another row; and
displaying the list on a list display screen based on the similarity.

10. A non-transitory computer readable medium storing a list display program that causes a computer to execute the following processing of:
selecting a target row, which is one of a plurality of rows, from a list including the plurality of rows;
calculating a similarity between data in the selected row and data in another row; and
displaying the list on a list display screen based on the similarity.
